(19) United States
(12) Patent Application Publication
(10) Pub. No.: US 2008/0118709 A1
(43) Pub. Date: May 22, 2008

(54) Vibration/shock isolators (V/SI's)

(76) Inventors: Steven C. Sims, Shelton, WA (US); Gary Sims, Shelton, WA (US); Johnathan F. Seil, Shelton, WA (US); Greg Winters, Shelton, WA (US)

Correspondence Address: RICHARD D. MULTER, 301 West Business Park Loop, SHELTON, WA, 98584, US

(21) Appl. No.: 11/880,477

(22) Filed: Jul. 20, 2007

Related U.S. Application Data
(60) Provisional application No. 60/832,527, filed on Jul. 20, 2006.
(60) Provisional application No. 60/837,904, filed on Aug. 14, 2006.

(51) Int. Cl. B32B 3/00

(52) U.S. Cl. 428/141

(57) ABSTRACT

Vibration/Shock/Isolators (V/SI's) which employ tuned, progressive resistance to deformation to isolate a user's anatomy or a protected instrumentality from shock and vibration. The V/SI may be wrapped around a handle to form a grip. A V/SI can also be fabricated in an unlimited number of other configurations to isolate a user's anatomy or any of an untold number of devices from shock and vibration.

### CROSS-REFERENCES TO RELATED APPLICATIONS

The benefits of the filing dates of the following provisional applications are claimed:

1. 60/832,527 filed 20 Jul. 2006

2. 60/837,904 filed 14 Aug. 1006

### TECHNICAL FIELD OF THE INVENTION

The present invention relates to novel tuned progressive resistance shock/vibration isolator (V/SI's) which can be used to advantage in a host of applications.

And, in another aspect, the present invention relates to novel, improved V/SI's which significantly increase the grip afforded a user in applications where the device is associated with a wielded instrument handle or other instrumentality which is intended to be grasped by a user or has a component provided for that purpose.

### BACKGROUND OF THE INVENTION

There have previously been disclosed and commercialized high performance (and highly successful) elongated, flat, elastomeric wraps for hand and power tools, weed eaters, lawn mowers, bicycles, motor cycles, archery bows, ball bats, and a host of other devices. Nevertheless, the search for superior devices continues.

### SUMMARY OF THE INVENTION

The present invention comprises novel V/SI devices which effectively isolate a user's hands or other anatomical part or any of a wide variety of instrumentalities from shock and vibration set up in an artifact separated from a user or protected instrumentality by the V/SI.

In addition, in applications where the device is to be grasped or kept in place between instrumentalities or components. V/SI devices employing the principles of the present invention afford an advantageously superior grip.

The devices disclosed herein are manufactured from an elastomeric material. NAVCOM® is one suitable material.

The V/SI's disclosed herein are fabricated from an elastomeric material. They have a substrate and integral pillars on at least one side of the substrate. Shocks and vibrations applied to the V/SI effect deformation of the pillars, which exhibit a progressive resistance to that deformation. The progressive resistance parameters can be tuned by selection of such factors as the configuration(s) of the pillars and the specifics of the elastomeric material from which a V/SI is made.

Tuned progressive resistance effectively reduces the transfer of shock and vibration energy and consequently effectively isolates the user or protected instrumentality from shock and vibration. This minimizes or even eliminates the discomfort which a user might otherwise experience and, in the case of a protected instrumentality, significantly lowers the possibility of shock or vibration damage.

The pillar(s) may have a circular, elliptical, square, triangular or other configuration; and pillars may be provided on both sides of the substrate.

A recess (or multiple recesses) may be optionally formed in each (or the) integral pillar of the device. At one end, the recess opens onto that end of the pillar opposite the substrate. The recess may extend through the substrate and open onto its opposite face, or it may have a blind inner end. Each pillar may have multiple open-ended recesses. The recesses may be of the through-bore or blind-end type or a mixture of those types; and the recesses may have any of many configurations. Pillars with recesses of different configurations may be employed in the same device.

Grasping or otherwise exerting pressure on a V/SI device with apertured pillars tends to produce suction akin to that of an octopus tentacle, improving the grip afforded by the device. The grip is further enhanced by the V/SI conforming to the contour of the hand or other agent pressing on the device due to an enhanced ability of the pillar(s) to deform and deflect attributable to the “hollowing out” of the pillar by the recess in that element. Progressive deformation resistance may be tuned by the use of recess-bearing pillars because of the discussed, enhanced ability of the thus hollowed-out pillars to deform under load.

Furthermore, air trapped in the pillar recess(es) can provide pneumatic cushioning, further contributing to the effectiveness of the novel V/SI devices of the present invention.

The objects, features, and advantages of the present invention will be apparent to the reader from the foregoing and the appended claims and as the ensuing detailed description and discussion proceeds in conjunction with the accompanying drawings.

### BRIEF DESCRIPTION OF THE DRAWINGS

FIG. 1 is a side view of a bat as disclosed in copending application No. (Docket No. 2053-111A) filed 19 Jul. 2007;

FIG. 2 is a fragment of the FIG. 1 bat equipped with a pillar-employing vibration damping grip formed from a device embodying the principles of the present invention;

FIG. 3 is a fragment of a grip similar to the grip shown in FIG. 2, but drawn to an enlarged scale to more clearly show details of the vibration damping device from which the grip is formed;

FIG. 4 is a plan view of the vibration damping device;

FIG. 5 is a fragment of FIG. 4 drawn to an enlarged scale;

FIG. 6 is a plan view showing the reverse side of the FIG. 4 V/SI;

FIG. 7 is a fragmentary section, taken substantially along line 7-7 of FIG. 5;

FIG. 8 is a sectional view showing how the chamfered edges of two successive turns of a FIG. 4 V/SI are overlapped when the V/SI is trained around a handle to form a grip as shown in FIG. 2;

FIG. 9 is a plan view of a second, strip-type, pillar-employing V/SI device embodying the principles of the present invention;

FIG. 10 is a partial section taken substantially along line 10-10 of FIG. 9;

FIG. 11 is a plan view of a device which has a variety of representative pillar styles; a V/SI embodying the principles of the present invention may have any one or any combination of the illustrated, or other, pillar styles;

FIG. 12 is a side view of the FIG. 11 device;

FIG. 13 is a section, taken substantially along line 13-13 of FIG. 11;

FIG. 14 is a plan view of a V/SI pad embodying the principles of the present invention;

FIG. 15 is a side view of the FIG. 14 pad;

FIG. 16 is a plan view of a second V/SI pad embodying the principles of the present invention; this pad has pillars on both sides of an integral substrate;

FIG. 17 is a side view of the FIG. 16 pad; and

FIG. 18 is an enlarged scale fragment of FIG. 17.

### DETAILED DESCRIPTION OF THE INVENTION

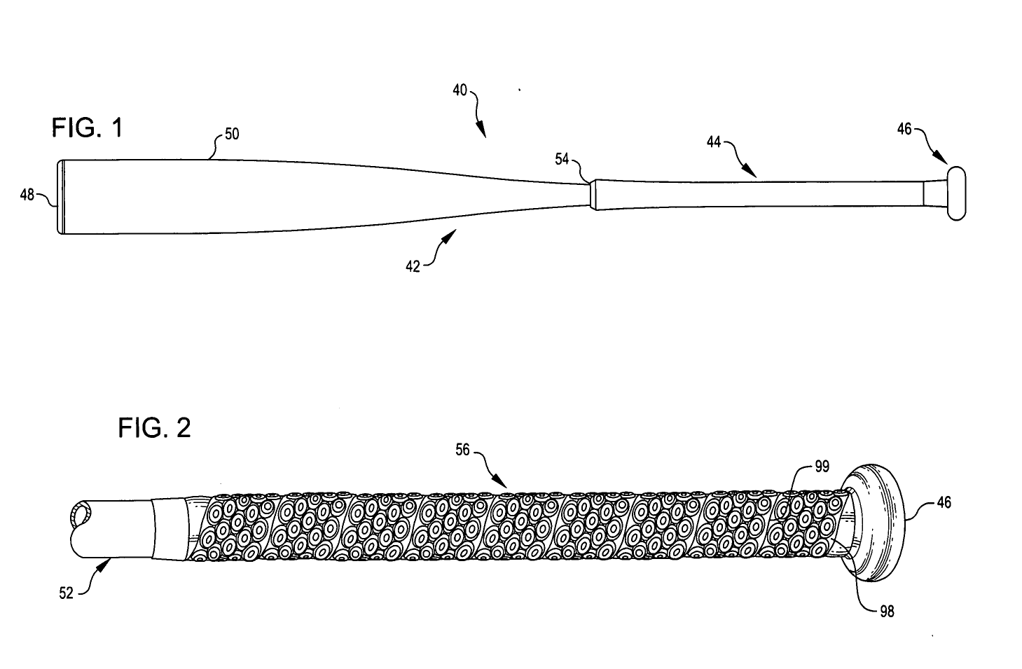

Referring now to the drawings, FIG. 1 depicts a bat 40 which has a core component 42, a handle 44, a knob 46, and a cap 48 at the end of core component 42. The core component 42 has a hollow barrel 50 and an integral, hollow stem 52 extending from, and axially aligned with, barrel 50.

Handle 44 surrounds the stem 52 of core component 42. Annular, elastomeric decouplers are installed between core component 42 and handle 44, preferably near or at opposite ends of the handle. The decouplers isolate handle 44 from core component 42, keeping shock (and to a significant extent other vibrations) from being transmitted to the batter's hands when a ball is struck. Consequently, the batter is not stung or otherwise subjected to pain or discomfort. This is per se advantageous and also improves performance by keeping the batter from flinching when swinging at a ball. One of the just-discussed decouplers is shown in FIG. 1 and identified by reference character 54.

Further, significant, isolation of a batter's hands from shock and other vibrations may be obtained by installing a grip 56 as shown in FIG. 2 on the handle 44 of bat 40. This grip isolates the user's hands from the bat by tuned, progressive resistance, which keeps pain- and discomfort-attributable energy from reaching the user's hands.

Grip 56 is fashioned by training an elastomeric wrap 58 as shown in FIGS. 4-7 around handle 44 in the helical manner shown in FIG. 2. Elastomeric wrap 58 is constructed in accord with, and embodies, the principles of the present invention.

Isolation from shock and vibration and the adverse effects those phenomena can cause is achieved by the use of the above-discussed tuned progressive resistance technology in wrap 58. To this end, integral pillars 60 are formed on an exposed side 62 of wrap substrate 64. Continuing deformation of pillars 60 results in progressively increasing resistance of the elastomeric material and highly efficient prevention of shock and vibration energy transfer.

The pillars may have the illustrated frustoconical shape or an elliptical, square, rectangular, triangular, or other configuration. A recess 66 may be formed in each integral pillar. At one end, the recess opens onto that exposed end 68 of the pillar opposite the substrate 64 (see FIG. 7). The recess may extend through the substrate and open onto its opposite face, or it may have a blind inner end. Each pillar may have multiple open-ended recesses, and they may be of the through-bore or blind-end type or a mixture of those types.

The recesses 66 of elastomeric wrap 58 have a conical configuration and a blind inner end 70.

The pillars 62 in which recesses 66 are formed have the above-mentioned frustoconical configuration; and there is one, centrally located aperture in each pillar. The pillars are closely packed with adjacent pillars touching. As discussed above, the use of recesses is one factor that may be employed in tuning the progressive resistance of the pillars.

Grasping grip 56 produces suction akin to that of an octopus tentacle, improving the grasp of the bat afforded by the grip. The grasp is further enhanced by virtue of grip 56 conforming to the contour of the batter's hand due to ability of the pillars 60 to deform and deflect.

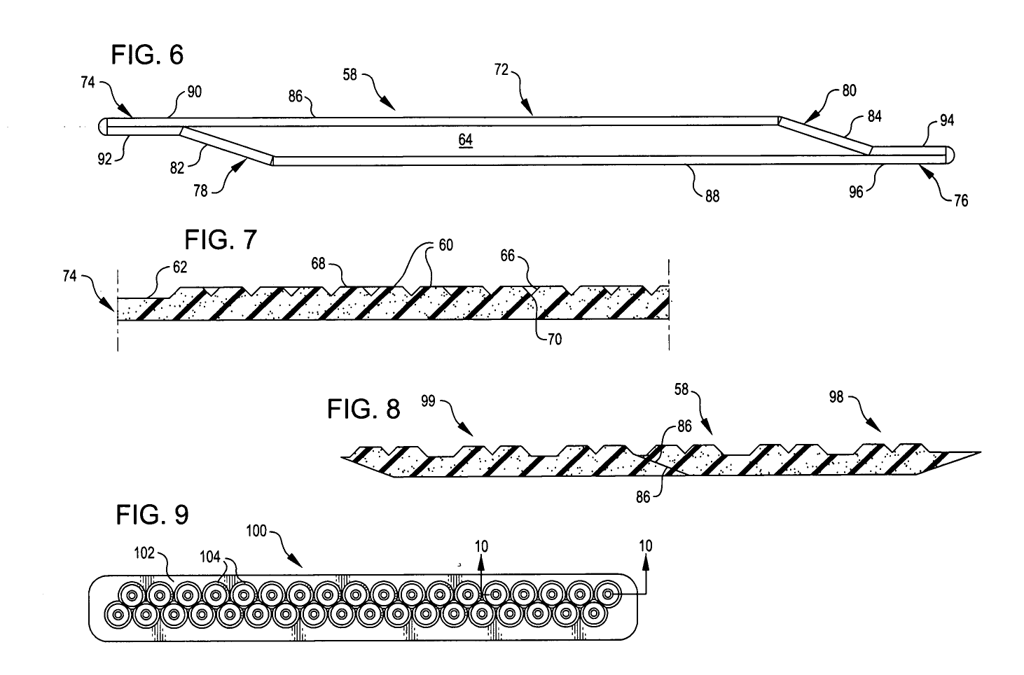

Referring now most particularly to FIGS. 2, 6, and 8, it was pointed out above that wrap 58 is trained around handle 44 in a helical manner in fashioning grip 56. Wrap 58 has a central section 72, relatively narrow, elongated, integral end segments 74 and 76, and transition sections 78 and 80 with edges 82 and 84 which angle from end segments 74 and 76 to the central section 72 of wrap 58. The edges 86 and 88 of wrap central section 72, the edges 90 and 92 of end segment 74, the edges 94 and 96 of end segment 76, and transition segment edges 82 and 84 are all chamfered as shown in FIG. 6. When wrap 58 is trained around handle 44 as shown in FIG. 2, a chamfered, central segment edge 86 (or 88) in one turn 98, and the adjacent segment of the same edge in the next turn 99 overlap in the manner shown in FIG. 8. Thus, grip 56 lies flat on handle 44 instead of bulging or bunching up as successive turns are laid down which might otherwise be the case.

Similarly, the tampered edges 82 and 84 of transition segments 78 and 80 and the chamfered edges 90 . . . 96 of elastomeric wrap end segments 74 and 76 cooperate in like manner to form a smooth, advantageously bulge-free grip.

It is also to be noted (see FIGS. 4 and 5) that the end segments 74 and 76 of elastomeric wrap 58 are free of the pillars 60 found in the central and transition segments 72, 78 and 80 of the wrap. Among other things, this allows segment 74 (and/or segment 76) to be tucked under the end 96 or 98 of the wrap to secure the wrap in place without forming a bulge in grip 56. Also, the winding of the wrap around a handle can be started without bunching or bulging of the wrap.

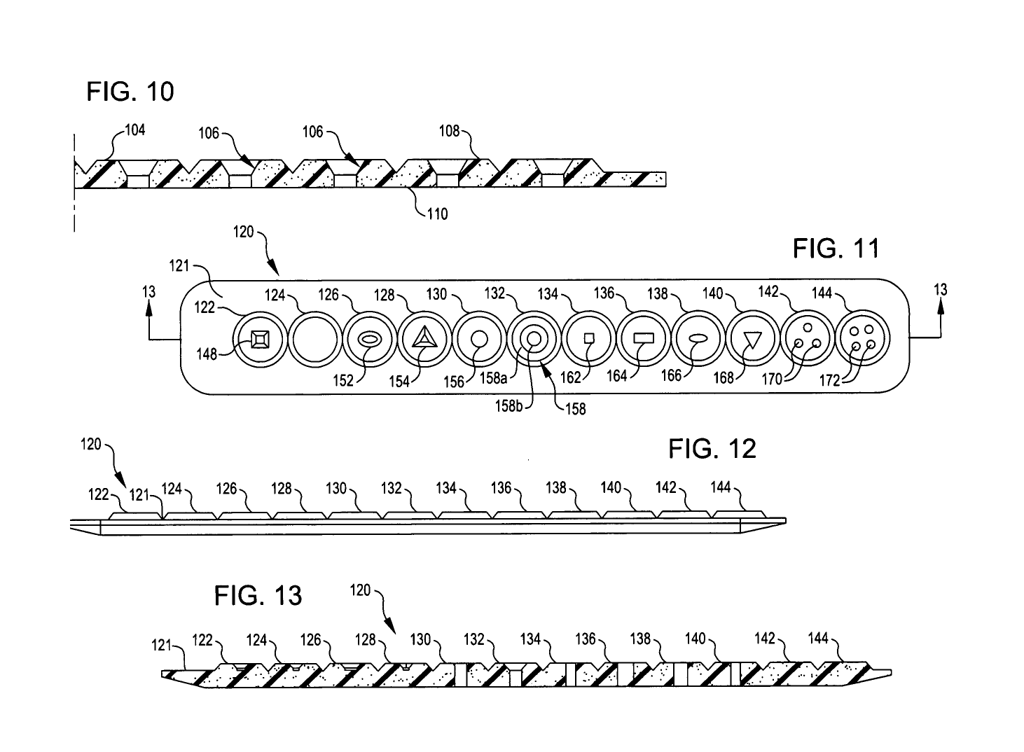

It is apparent from the foregoing that a wide variety of alternate embodiments are subsumed by the compass of the present invention. FIGS. 9 and 10 depict a wrap 100 embodying the principles of the present invention which has a substrate 102, pillars 104, and centrally located apertures 106 in the pillars. These pillars in this wrap do not have blind ends, but are the through-type in that they extend between and open onto the tops 108 of pillars 104 and the opposite (or reverse) side 110 of wrap 100; i.e., the back or bottom side of substrate 102.

FIGS. 11-13 depict a wrap 120 with a substrate 122 and other, exemplary forms of pillars; viz.:

| Pillar | Recess |
|---|---|
| 124 | 148, square with tapered sides |
| 126 | None |
| 128 | 152, elliptical with tapered sides |
| 130 | 154, triangular with tapered sides |
| 132 | 156, circular with straight sides |
| 134 | 158, circular with communicating tapered and straight |
| | sided, communicating segments 158a and 158b |
| 136 | 162, square with straight sides |
| 138 | 164, rectangular with straight sides |
| 140 | 166, elliptical with straight sides |
| 142 | 168, triangular with straight sides |
| 144 | 170, multiple apertures (Version 1) |
| 146 | 172, multiple apertures (Version 2) |

Also, and as is shown in FIG. 13, a single wrap embodying the principles of the present invention may have pillars with both blind and through apertures, as well as pillars with apertures of different configurations, pillars with multiple apertures, and pillars with no apertures at all.

Above, wrap 58 was disclosed by relating it to an exemplary application in which the wrap is employed to form a grip on a bat handle. This is not intended to limit the scope of the invention in that wrap 58 wrap 120, and other wraps embodying the principles of the present invention may be employed equally well, and in the same manner, to form wraps on other handles. As examples only, those of: golf clubs; bicycle and motorcycle handlebars; hammers, lawn mowers, weed-eaters; and a host of other products.

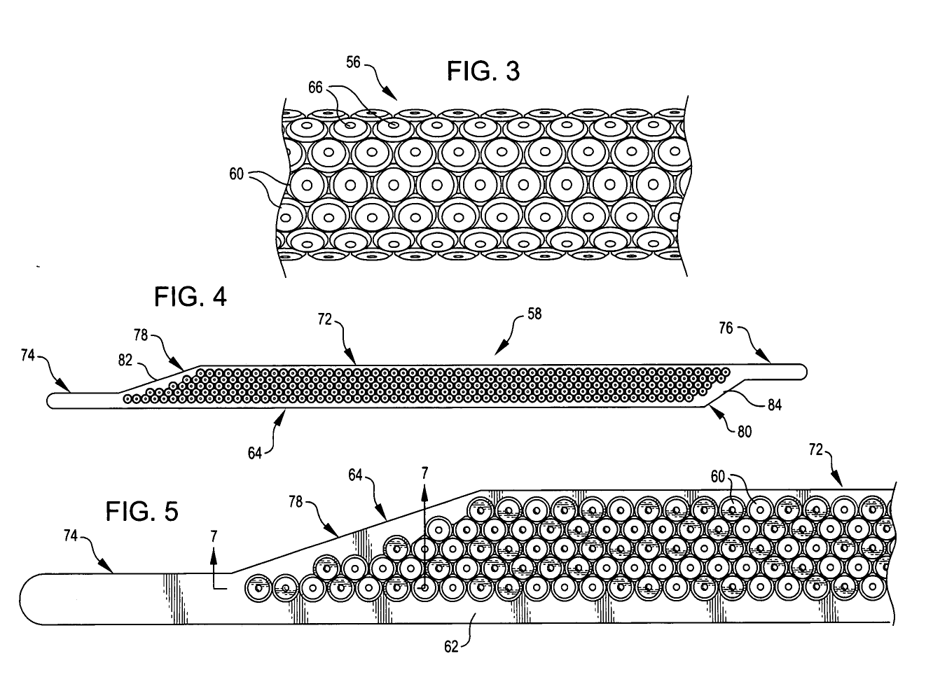

The principles of the present invention may be embodied in a wide variety of artifacts other than the elongated wraps discussed above and illustrated in FIGS. 1-13.

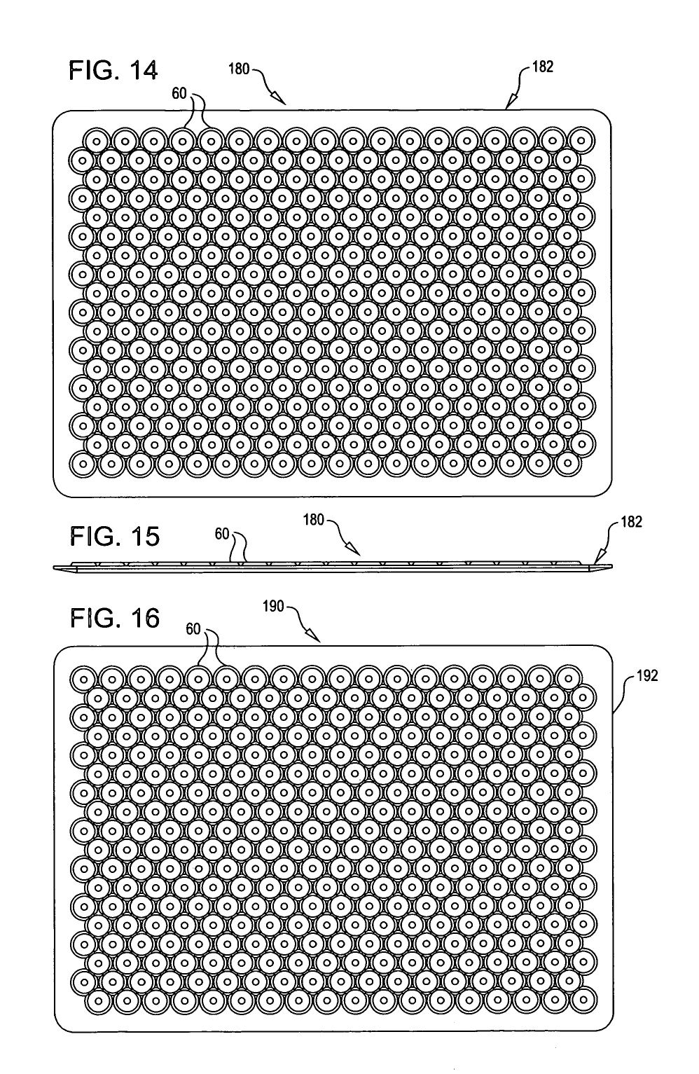

FIGS. 14 and 15, for example, depict an elastomeric pad 180 with a substrate 182 and closely-packed pillars 60 on one side of the substrate.

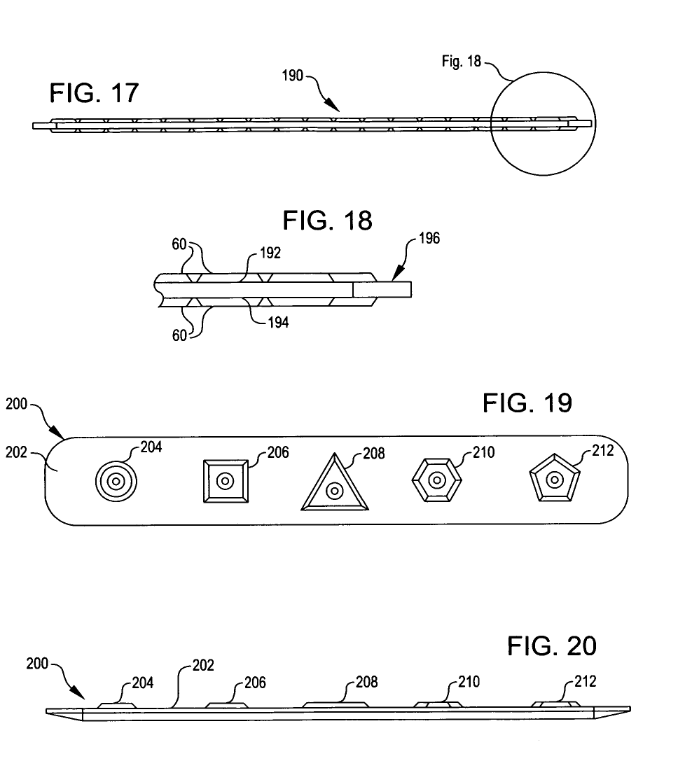

FIGS. 16-18 similarly depict a pad 190 which differs from pad 180 in that there are closely-packed sets or arrays of pillars 60 on both sides 192 and 194 of substrate 196.

Pads embodying the principles of the present invention need not have the rectangular shape of pads 180 and 190, but may be of generally any desired, geometric configuration.

Pads such as those identified by reference characters 188 and 190 may be used for many different purposes: as examples only, to isolate human anatomy from shock and vibration and to similarly protect a host of artifacts and devices from the adverse effects of shock and vibration.

It was pointed out above that V/SI's employing the principles of the present invention may have pillars with any of a wide variety of configurations and that combinations of different pillars may be used in a single device. A V/SI with both of these features is illustrated in FIGS. 19 and 20 and identified by reference character 200.

V/SI has a substrate 202 and pillars 204 . . . 212 of circular, square, triangular, hexagonal, and pentagonal configurations. While apertured pillars are shown in FIG. 19, it is to be understood that apertures need not be provided, irrespective of the pillar configuration.

Also, FIGS. 19 and 20 make it clear that pillars need not touch, or even be in close proximity, for a V/SI embodying the principles of the present invention to be effective.

The invention may be embodied in many forms without departing from the spirit or essential characteristics of the invention. The present embodiments are therefore to be considered in all respects as illustrative and not restrictive, the scope of the invention being indicated by the appended claims rather than by the foregoing description; and all changes which come within the meaning and range of equivalency of the claims are therefore intended to be embraced therein.

1. An elastomeric V/SI comprising:
a substrate; and
an array of integral pillars protruding from one side of the substrate.

2. A V/SI as defined in claim 1 in which the pillars are tuned to offer a selected pattern of progressive resistance to deformation of the pillars caused by the imposition of shock and vibration on the V/SI.

3. A V/SI as defined in claim 2 wherein each pillar touches at least one other pillar.

4. A V/SI as defined in claim 1 which is an elongated strip;
there being integral, pillar-free segments at opposite ends of the strip.

5. A V/SI as defined in claim 1 which is so shaped as to enable it to function as a cushion or pad.

6. A V/SI as defined in claim 1 which has pillars protruding from first and second opposite sides of the substrate.

7. The combination of:
a device comprising a handle; and
a V/SI as defined in claim 1 wrapped around the handle to isolate one using the device or a protected instrumentality from shock and vibration.

8. A combination as defined in claim 7 wherein the pillars, and the elastomer from which the V/SI is made are so selected to promote the tenacity with which the user can grasp the handle.

9. A combination as defined in claim 7 wherein the pillars can distort to match the contours of a user's hand(s).

10. A combination as defined in claim 7 in which the edges of the V/SI are so chamfered that, when the V/SI is wrapped on the handle and an edge of one turn is overlaid by the edge of a subsequent turn, the combined thickness of the two edges is approximately the same as the thickness of the substrate on which the pillars are located.
